(19) United States
(12) Patent Application Publication
(10) Pub. No.: US 2023/0061389 A1
(43) Pub. Date: Mar. 2, 2023

(54) Crane Collision Avoidance System

(71) Applicant: Marmon Crane Services, Inc., Chicago, IL (US)

(72) Inventors: Peter M. BARTEK, Ledgewood, NJ (US); Timothy J. BENJAMIN, Sharpsburg, GA (US); Alec FUGLEM, Glenview, IL (US); Arnold MABEE, Fruita, CO (US)

(73) Assignee: Marmon Crane Services, Inc., Chicago, IL (US)

(21) Appl. No.: 17/897,709

(22) Filed: Aug. 29, 2022

Related U.S. Application Data
(60) Provisional application No. 63/238,746, filed on Aug. 30, 2021.

(51) Int. Cl. B66C 15/04; B66C 13/46

(52) U.S. Cl. CPC B66C 15/045; B66C 13/46

(57) ABSTRACT

A crane collision avoidance system is disclosed herein that is configured to monitor a crane and an environment surrounding the crane. The crane collision avoidance system may include one or more devices or sensors that are selectively attached to a crane. In various embodiments, the crane collision avoidance system may include a computer system configured to use images or information obtained via the devices or sensors to monitor a crane operator's blind spots and movement of the crane and its components, detect potential collisions with danger objects within the environment surrounding the crane, detect counterweight movement, monitor a load zone, detect when a boom or any other component of a crane has become energized, and/or otherwise provide improved situational awareness to a crane operator.

### RELATED APPLICATIONS

This application claims priority to U.S. Provisional Patent Application No. 63/238,746, filed Aug. 30, 2021, titled “Crane Collision Avoidance System with Blind Spot Monitoring and Counter Weight Movement Detection,” the content of which is incorporated herein by reference in its entirety.

### FIELD OF THE INVENTION

The present invention relates to crane operations and, more particularly, to a crane collision avoidance system configured to provide improved situational awareness to an operator of a crane.

### BACKGROUND OF THE DISCLOSURE

Mobile wheeled cranes are fraught with many challenges—many of which are related to safety. The nature of a crane's movement and the various components that make up the crane can create a number of safety hazards related to operator visibility. For example, the boom, counterweight, outriggers, alternate movable cab, and/or the load being moved by the crane can all create additional blind spots beyond just the blind spots created by the vehicle's “A” frame. These potential obstacles and blind spots can be in the front, back, side, and/or in the counterweight swing of the crane. Further, the side mirrors themselves may cause a blind spot. For example, one side of a crane is shaped such that the side mirror is a greater distance away to be useful to the operator, thus creating another potential blind spot. Each of these blind spots can be the cause of a potential collision with an object (e.g., a building, another vehicle, or any other object or individual) within a proximity of the crane. Additionally, when a crane lifts a load, objects or individuals may be present or otherwise find themselves underneath the load. Such objects or individuals may not be visible to the crane operator and/or may be unaware of the dangerous situation. Thus, there is a need for a system that improves the peripheral vision of a crane operator and improves the situational awareness of both the crane operator and individuals within a working area to reduce the likelihood of a potential collision or other accident.

### SUMMARY OF THE INVENTION

Aspects of this disclosure relate to a crane collision avoidance system configured to provide improved situational awareness to an operator of a crane. In various embodiments, the crane collision avoidance system may include one or more devices or sensors that are attached to a crane and configured to monitor the crane and an environment surrounding the crane. The one or more sensors or devices may be selectively attached to one or more components of a crane at a plurality of locations on the top and sides of the crane. In various embodiments, the crane collision avoidance system may further include a computer system configured to use images or information obtained via the one or more sensors or devices to monitor a crane operator's blind spots and movement of the crane and its components (including the boom and any load being carried or lifted by the crane), detect potential collisions with danger objects within the environment surrounding the crane, detect counterweight movement, monitor a load zone, detect when a boom or any other component of a crane has become energized, and/or otherwise provide improved situational awareness to a crane operator.

According to one aspect of this disclosure, the crane collision avoidance system described herein may be configured to provide blind spot monitoring functionality to a crane operator. For example, one or more devices or sensors may be specifically positioned around a crane to capture images of blind spots created by the “A” frame of a cab of the vehicle, the rear-view side mirrors of the crane, and/or other components of the crane that may create a blind spot for the crane operator. In various embodiments, the crane collision avoidance system may be configured to receive images captured by the one or more devices or sensors and cause the images to be displayed in real-time via one or more audio and/or visual display systems located within, proximate to, or remote from the crane. In some embodiments, individual displays may be located within a cab of the crane in locations at which areas not visible to the crane operator would otherwise be visible. In some embodiments, the crane collision avoidance system may be configured to provide an operator of a crane with a 360-degree view of the area surrounding the crane.

According to another aspect of this disclosure, the crane collision avoidance system described herein may be configured to identify objects within a proximity of the crane as danger objects representing a potential collision based on a path of the object and/or the movement of the crane. In various embodiments, the crane collision avoidance system may be configured to determine location, speed, and/or direction data for one or more objects within a vicinity of a crane and identify in real-time whether an object comprises a danger object based on the determined location, speed, and/or direction of the object and telematics information indicating a position, orientation, speed or direction of movement, and/or other information related to the operation of a crane. In various embodiments, the crane collision avoidance system may be configured to provide audio, visual, haptic, and/or other types of warnings in response to detection of a danger object representing a potential accident or collision. In some embodiments, the crane collision avoidance system may be configured to automatically take action with respect to movement of the crane in response to detection of a potential accident or collision. For example, in response to detecting a potential accident or collision, the crane collision avoidance system may be configured to cause one or more components of the crane to move automatically or stop moving automatically in order to avoid a potential accident or collision.

According to another aspect of this disclosure, the crane collision avoidance system described herein may be configured to detect movement of a crane counterweight and provide alerts of potential danger (e.g., due to a detected counterweight swing). According to another aspect of this disclosure, the crane collision avoidance system described herein may be configured to identify and monitor a load zone (i.e., an area under which any individual or object may be in danger due to a falling load or debris) and provide alerts in response to the detection of a potential accident or danger. According to another aspect of this disclosure, the crane collision avoidance system described herein may be configured to detect when a boom or any other component of a crane has become energized due to contact with a power source (such as a powerline) and provide alerts to make the crane operator, other crane personnel, and/or other individuals within a proximity of the crane aware of the potential danger.

These and other objects, features, and characteristics of the invention disclosed herein will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The present invention is illustrated by way of example and not limited in the accompanying figures in which like reference numerals indicate similar elements and in which:

FIG. 1 depicts a pictorial view of a crane equipped with an example crane collision avoidance system, according to one or more aspects described herein;

FIG. 2 depicts an overhead view of an example monitoring subsystem of a crane collision avoidance system equipped on a crane, according to one or more aspects described herein; and

FIG. 3 depicts a block diagram of an example crane collision avoidance system, according to one or more aspects described herein.

These drawings are provided for purposes of illustration only and merely depict typical or example embodiments. These drawings are provided to facilitate the reader's understanding and shall not be considered limiting of the breadth, scope, or applicability of the disclosure. For clarity and ease of illustration, these drawings are not necessarily drawn to scale.

### DETAILED DESCRIPTION

In the following description of various examples of the invention, reference is made to the accompanying drawings, which form a part hereof, and in which are shown by way of illustration various example structures, systems, and steps in which aspects of the invention may be practiced. It is to be understood that other specific arrangements of parts, structures, example devices, systems, and steps may be utilized, and structural and functional modifications may be made without departing from the scope of the present invention. Also, while the terms “top,” “bottom,” “front,” “back,” “side,” and the like may be used in this specification to describe various example features and elements of the invention, these terms are used herein as a matter of convenience, e.g., based on the example orientations shown in the figures. Nothing in this specification should be construed as requiring a specific three-dimensional orientation of structures in order to fall within the scope of this invention.

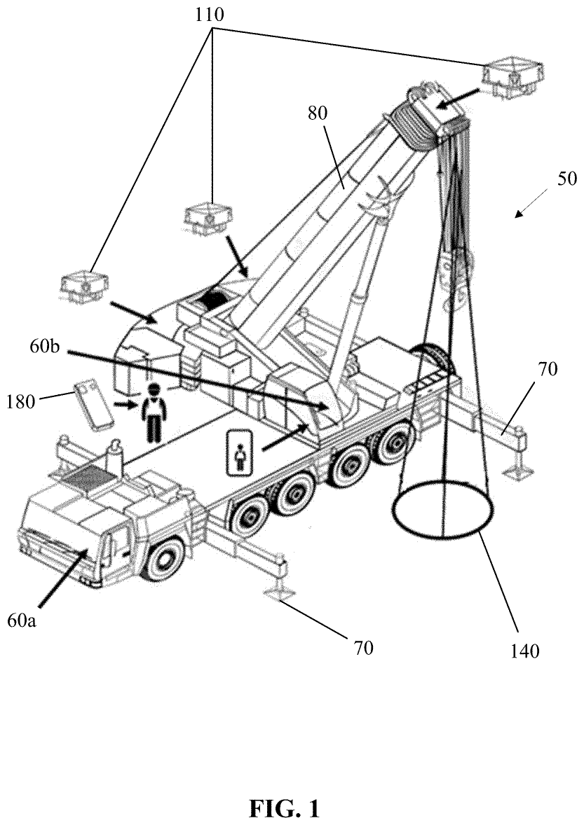

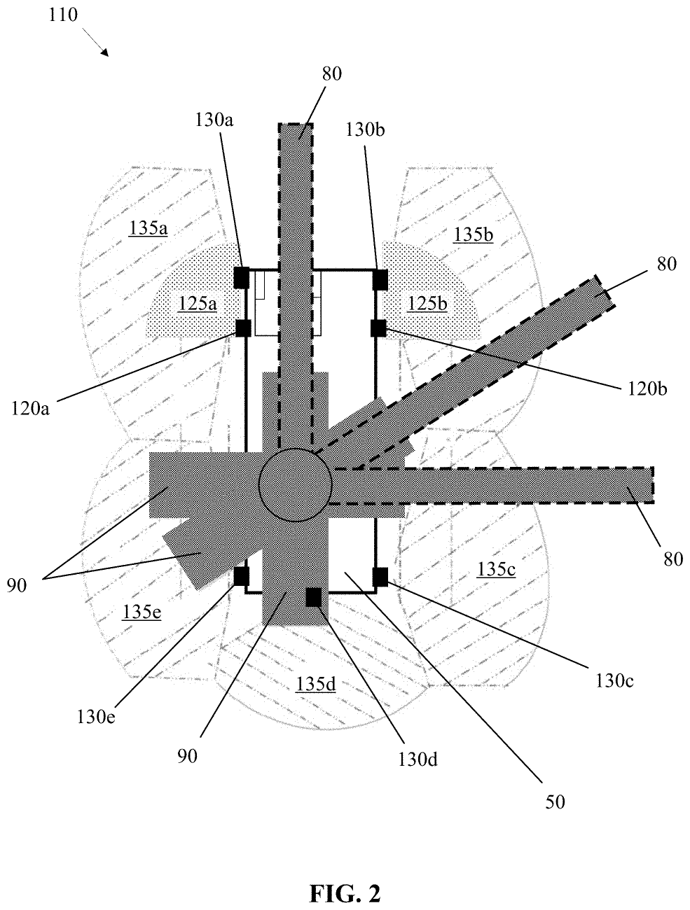

FIGS. 1-3 depict a crane collision avoidance system 100 configured to provide improved situational awareness to an operator of a crane, according to one or more aspects described herein. For example, FIG. 1 depicts a pictorial view of a crane 50 equipped with a crane collision avoidance system 100, and FIG. 2 depicts a top view of a monitoring subsystem 110 of a crane collision avoidance system 100 equipped on a crane 50. As depicted in FIG. 1 and FIG. 2, crane 50 may include one or more cabs 60 having an “A” frame, a set of outriggers 70, a boom 80, a counterweight 90, and/or one or more other components. In various embodiments, crane collision avoidance system 100 described herein may equipped on a mobile crane (e.g., crane 50), a fixed crane, and/or one or more other types of cranes. In some embodiments, crane collision avoidance system 100 described herein may be configured to be similarly equipped on one or more other types of vehicles or machines.

In various embodiments, crane collision avoidance system 100 may include a monitoring subsystem 110 comprising one or more devices or sensors configured to monitor an environment surrounding a crane, detect movement of crane components or objects within the environment surrounding the crane, or otherwise provide improved situational awareness to a crane operator. For example, the one or more devices or sensors may include depth cameras, lasers, accelerometer devices, aimed audio devices, ultrasonic sensors, various other types of cameras, LIDAR radar sensors, photoelectric sensors, infrared sensors, internet of things (IoT) devices, GPS devices, and/or other types of devices or sensors. In some embodiments, monitoring subsystem 110 may include various image capturing devices, such as cameras to capture what is happening external to the vehicle in real-time so that it may be displayed on a display subsystem (described further herein). In some embodiments, monitoring subsystem 110 may include LIDAR radar sensors and/or other object detecting sensors (such as ultrasonic sensors, photoelectric sensors, and infrared sensors) to detect objects within a proximity of the crane. Other devices or sensors may also be simultaneously utilized, such as GPS devices crane telematic sensors, IoT devices, and/or other devices or sensors. In some embodiments, crane telematic sensors may be configured to monitor the vehicle by using GPS device and onboard diagnostics to record movements on a computerized map, such as with a GPS receiver, an engine interface, an input/output interface (expander port) in the vehicle, a SIM card, an accelerometer device, and/or other components. In various embodiments, crane collision avoidance system 100 may be configured to gather data from these devices and/or sensors and from external sources to provide improved situational awareness to an operator and take affirmative action when necessary to avoid an accident.

In various embodiments, the one or more devices or sensors of monitoring subsystem 110 may be selectively attached to one or more components of a crane at a plurality of locations on the top and sides of the crane. In some embodiments, the devices and/or sensors of monitoring subsystem 110 may be selectively attached on the crane to enable monitoring subsystem 110 to effectively monitor the environment surrounding the crane (particularly any blind spots out of sight of the crane operator) and detect objects that may be at risk of a collision with the crane or one its components. Such objects may be referred to herein as “danger objects.”

In various embodiments, the one or more devices or sensors of monitoring subsystem 110 may comprise at least one or more image capturing devices 120, one or more object detecting sensors 130, and/or one or more other devices or sensors. The one or more image capturing devices 120 may comprise one or more cameras, sensors, lasers, and/or other image capturing devices. The one or more object detecting sensors 130 may include distance and/or object sensors, such as ultrasonic sensors, LIDAR radar sensors, photoelectric sensors, infrared sensors, and/or one or more other sensors that may be configured to detect an object. In some embodiments, the one or more other devices or sensors may include devices or sensors configured to determine, provide, or sense pressure, light, force, strain, magnetic field, capacitive sense, RFID, electric field, motion, acceleration, orientation, position, Radio Frequency triangulation, light triangulation, proximity, gravitational field strength and/or direction. For example, movement of a counterweight or boom may be detected by a gyroscope attached to either the boom or the counterweight. Any other type of device or sensor that may provide information necessary to perform the functionality described herein is expressly contemplated and within the scope of the invention.

FIG. 2 depicts an example arrangement of the one or more devices or sensors of monitoring subsystem 110 mounted on a crane, according to one or more aspects described herein. In various embodiments, image capturing device(s) 120 may be mounted on a cab of the crane to monitor any blind spots created by the “A” frame of the cab or side mirrors attached to the cab. For example, as depicted in FIG. 2, image capturing devices 120a and 120b may be attached to the crane and configured to monitor vision areas 125a and 125b, respectively. In various embodiments, object detecting sensor(s) 130 may be attached at various points around the crane to monitor movement and/or objects in the environment surrounding the crane. In some embodiments, object detecting sensor(s) 130 may be attached at various points around the crane to monitor any movement within a proximity of the crane. In some embodiments, object detecting sensor(s) 130 may be attached at various points around the crane to monitor the entire area in which objects present may be at risk of collision with the crane (or one of its components), including a load being carried or lifted by the crane. In some embodiments, object detecting sensor(s) 130 may be attached at various points around the crane to provide 360 degree monitoring around the crane. For example, as depicted in FIG. 2, object detecting sensors 130a, 130b, 130c, 130d, and 130e may be attached to the crane and configured to monitor detection areas 135a, 135b, 135c, 135d, and 135e, respectively.

In some embodiments, one or more image capturing devices 120 and one or more object detecting sensors 130 may be mounted at any point not obstructed by counterweight 90 and/or one or more other components. However, in various embodiments, one or more image capturing devices 120 and one or more object detecting sensors 130 may be mounted in any appropriate location to enable monitoring subsystem 110 to sufficiently monitor a crane operator's blind spots and movement of the crane and its components (including the boom and any load being carried or lifted by the crane), detect potential collisions with danger objects within the environment surrounding the crane, detect counterweight movement, monitor a load zone, detect when a boom or any other component of a crane has become energized, and/or one or more other capabilities described herein.

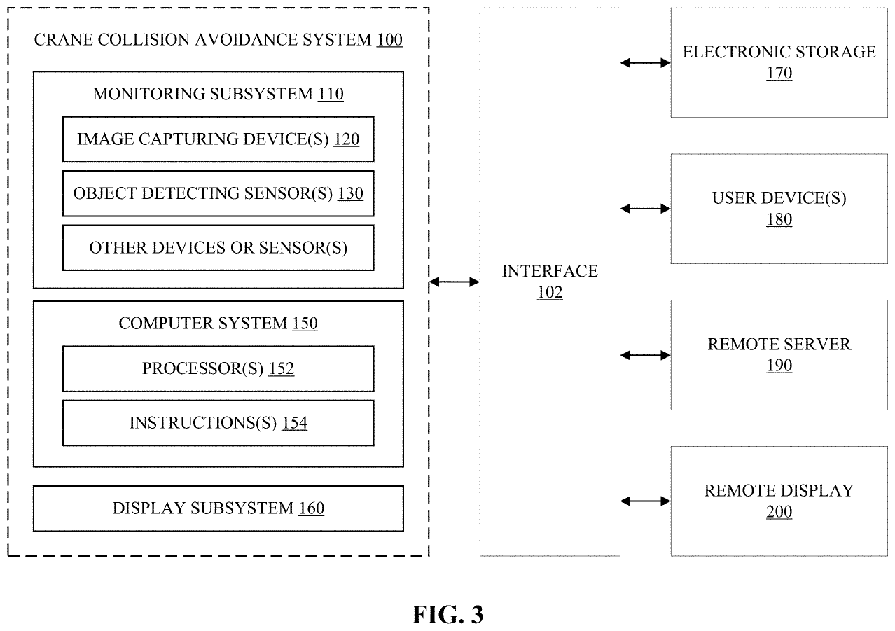

In various embodiments, monitoring subsystem 110 may be configured to interface or otherwise communicate with one or more other components of crane collision avoidance system 100. For example, FIG. 3 depicts a block diagram of crane collision avoidance system 100, according to one or more aspects described herein. In various embodiments, in addition to monitoring subsystem 110, crane collision avoidance system 100 may further include a computer system 150, a display subsystem 160, and/or one or more other components. Crane collision avoidance system 100 may interface with one or more external entities (e.g., electronic storage 170, one or more user device(s) 180, remote server 190, and remote display 200) via a network (or interface 102).

In various embodiments, computer system 150 may include one or more physical processor(s) 152, instructions 154, and/or one or more other components. The one or more physical processor(s) 152 (herein referred to interchangeably as “processor(s) 152” and “processor 152” for convenience) may be configured to provide information processing capabilities in crane collision avoidance system 100. As such, processor(s) 152 may comprise one or more of a digital processor, an analog processor, a digital circuit designed to process information, a central processing unit, a graphics processing unit, a microcontroller, an analog circuit designed to process information, a state machine, and/or other mechanisms for electronically processing information.

Processor(s) 152 may be configured to execute one or more computer readable instructions 154. When executed by the one or more processors 152, the computer readable instructions 154 may program processor(s) 152 (and computer system 150) to perform various functions of crane collision avoidance system 100. For example, based on information received from monitoring subsystem 110, computer readable instructions 154 may cause processor(s) 152 to detect a potential accident or collision with a danger object, generate an alert signal, provide instructions to the vehicle operator to slow down, turn, or stop, take affirmative action to avoid an accident or collision (e.g., activate an interlock of the crane) if the crane operator does not take timely action, and/or implement other features of crane collision avoidance system 100 described herein. As used herein, for convenience, the crane collision avoidance system 100 will be described as performing various operations, when, in fact, the computer readable instructions 154 program processor(s) 152 (and computer system 150) to perform the various operations described herein.

In various embodiments, crane collision avoidance system 100 may be configured to provide blind spot monitoring functionality to a crane operator. For example, one or more devices or sensors of monitoring subsystem 110 (e.g., one or more image capturing devices 120) may be specifically positioned around a crane to capture images of blind spots created by the “A” frame of a cab of the vehicle, the rear-view side mirrors of the crane, and/or other components of the crane that may create a blind spot for the crane operator. In some embodiments, the one or more devices or sensors of monitoring subsystem 110 may include lens-based cameras, CCD cameras, CMOS cameras, video cameras, or any other type of device or sensor configured to capture an image or series of images. In some embodiments, the one or more devices or sensors of monitoring subsystem 110 may optionally include preprocessing means for preprocessing captured images or sensor data. For example, preprocessing means may include means for performing data compression, enhancement, information retrieval, data mining, deriving features of items of interest in certain pre-defined areas or regions of interest and the surrounding areas, and/or other preprocessing functionality. In some embodiments, the one or more devices or sensors of monitoring subsystem 110 may be configured to convey raw image data or any preprocessed data for processing or viewing by a data processing system located locally or remote to monitoring subsystem 110. For example, in some embodiments, preprocessing of images captured or sensor data obtained by one or more devices or sensors of monitoring subsystem 110 may be performed by computer system 150 of crane collision avoidance system 100.

In various implementations, crane collision avoidance system 100 may be configured to receive images captured by one or more devices or sensors of monitoring subsystem 110 and cause the images captured by the one or more devices or sensors of monitoring subsystem 110 to be displayed in real-time via display subsystem 160. For example, display subsystem 160 may include one or more of audio and/or visual display systems located within or proximate to the crane. In some embodiments, an audio and/or visual display system located within or proximate to the crane may include an audio spotlight, a hologram display, an LED display, an LCD display, a dashboard (or in-dash) display, an augmented reality display, and/or one or more other types of visual displays within a field of view of a crane operator or other crane personnel. In various embodiments, crane collision avoidance system 100 may be configured to generate a display to be provided to the crane operator, other crane personnel, or individuals remote from the crane via display subsystem 160, one or more user devices 180, and/or remote display 200. In some embodiments, one or more user device 180 may comprise user devices or other portable devices of other crane personnel within a proximity of the crane. In some embodiments, remote display 200 may comprise a display system accessible remotely by one or more individuals remote from the crane.

In various embodiments, crane collision avoidance system 100 may be configured to receive images and other data captured by one or more devices or sensors of monitoring subsystem 110 and generate one or more displays providing real-time images of blind spots of the crane operator. For example, crane collision avoidance system 100 may be configured to display areas surrounding the crane that are blocked by the obstruction of the “A” pillar, side mirrors of the crane cab, and/or are otherwise in blind spots on displays of display subsystem 160. In some embodiments, display subsystem 160 may include one or more display devices inside the cab of the crane in locations at which areas not visible to the crane operator would otherwise be visible. For example, display subsystem 160 may include display devices on the interior of the “A” frame to enable a crane operator to visualize that area surrounding the crane as if the “A” frame was not blocking the view of the crane operator.

In various embodiments, crane collision avoidance system 100 may be configured to receive images and other data captured by one or more devices or sensors of monitoring subsystem 110 and generate a view of the environment surrounding the crane. For example, crane collision avoidance system 100 may be configured to receive images captured by one or more image capturing devices 120, sensor data captured by one or more object detecting sensors 130, and/or other data captured by devices or sensors of monitoring subsystem 110 and generate a display as described above that provides improved situational awareness to the crane operator, other crane personnel, or individuals remote from the crane by depicting all objects within a proximity of the crane. In some embodiments, this display may comprise a 360-degree view of the area surrounding a crane.

In various embodiments, crane collision avoidance system 100 may be configured to identify objects and/or determine attributes or objects or areas within a proximity of a crane. For example, crane collision avoidance system 100 may be configured to identify a size, shape, color, texture, and/or other attributes of objects within a proximity of a crane. In some embodiments, crane collision avoidance system 100 may be configured to identify an object based on attributes determined for that object. In some embodiments, crane collision avoidance system 100 may be configured to provide an indication of attribute(s) determined for an object and/or an identification of an object (or type of object) via one or more displays of display subsystem 160. For example, crane collision avoidance system 100 may be configured to provide, in association with an object, an indication of attribute(s) associated with that object and/or an identification of that object (or a type of object for that object) when that object is displayed via one or more displays of display subsystem 160.

In various embodiments, crane collision avoidance system 100 may be configured to detect potential collisions with danger objects within the environment surrounding the crane. For example, crane collision avoidance system 100 may be configured to detect danger objects representing a potential collision based on a path of the object and/or the movement of the crane. In some embodiments, crane collision avoidance system 100 may be configured to detect danger objects representing a potential collision based on the triangulation of data provided from the one or more object detecting sensors 130 and/or other devices or sensors of monitoring subsystem 110. For example, crane collision avoidance system 100 may be configured to measure and track a series or network of triangles in order to determine the distances and relative positions of the one or more object detecting sensors 130 spread over the vehicle. In some embodiments, crane collision avoidance system 100 may be configured to detect a danger object by measuring the length of one side of each triangle and deducing its angles and the length of the other two sides by observation from this baseline.

In various embodiments, crane collision avoidance system 100 may be configured to process in real-time the images, sensor data, and/or other information received from the one or more devices or sensors of monitoring subsystem 110 to determine location, speed, and/or direction data for one or more danger objects within a vicinity of a crane. In various embodiments, crane collision avoidance 100 may be configured to track identified objects and predict a future location and/or a route of the one or more objects using a predictive algorithm and/or a trajectory analysis of the one or more objects. In some embodiments, crane collision avoidance system 110 may be configured to detect potential collisions with danger objects using one or more techniques described in U.S. patent application Ser. No. 15/133,935, entitled “Anti-Collision Device and System for Use with a Rail Car,” filed Apr. 20, 2016, and in U.S. patent application Ser. No. 16/930,974, entitled “Interactive Safety System for Vehicles,” filed Jul. 16, 2020, the content of each of which is hereby incorporated by reference herein in their entirety.

In various embodiments, crane collision avoidance 100 may be configured to identify in real-time whether an object represents a danger object (i.e., an object that may be at risk of a collision with the crane or one its components) based on the application of a predictive algorithm and/or trajectory analysis on the one or more objects and/or knowledge of the current movement or operation of the crane. For example, crane collision avoidance 100 may be configured to identify in real-time whether an object represents a danger object based on location, speed, and/or direction data for the object and knowledge indicating a movement of the boom with respect to the object. In some embodiments, knowledge indicating a movement of the boom with respect to the object may be obtained from a computer system of the crane or otherwise determined based on information received from monitoring subsystem 110 using the techniques described herein. In various embodiments, crane collision avoidance system 100 may be configured to obtain crane telematics information indicating a position, orientation, speed or direction of movement, and/or other information related to the operation of a crane. In various embodiments, crane collision avoidance system 100 may be configured to detect objects representing a potential accident or collision based on information associated with the object determined based on information received from the one or more sensors of monitoring subsystem 110 and the crane telematics information obtained from the crane or determined based on information received from the one or more sensors of monitoring subsystem 110.

In various embodiments, crane collision avoidance system 100 may be configured to provide audio, visual, haptic, and/or other types of warnings in response to detection of a danger object representing a potential accident or collision. For example, crane collision avoidance system 100 may be configured to provide a vibrating seat or haptic warning to the crane operator when a potential collision or accident is detected. In another example, crane collision avoidance system 100 may be configured to provide external, automatic, audible warnings outside of the crane to provide a warning to crane personnel and/or other individuals in the working area of a potential accident or collision. In some embodiments, crane collision avoidance system 110 may also be configured to alert a crane operator, other crane personnel, or other individuals in a working area of the crane of potential accidents or collisions with danger objects using one or more other techniques. For example, crane collision avoidance system 110 may be configured to alert a crane operator, other crane personnel, or other individuals in a working area of the crane of potential accidents or collisions using one or more techniques described in U.S. patent application Ser. No. 16/930,974, entitled “Interactive Safety System for Vehicles,” filed Jul. 16, 2020, the content of which is incorporated by reference herein in its entirety.

In some embodiments, crane collision avoidance system 100 may be configured to highlight detected danger objects and/or other identified objects on one or more displays of display subsystem 160. For example, in one or more displays provided by display subsystem 160 or otherwise provided via one or more user devices 180 or remote display 200, identified danger object may be highlighted in a first color if the danger object is potentially in a path of an accident or a collision and the danger object may be highlighted in a second color if the danger object is imminently in a path of an accident or a collision with the crane. In some embodiments, detected danger objects may be represented with blinking colors, circles around the danger object, blinking circles around the object, and/or otherwise highlighted or emphasized to draw attention to the danger object by the crane operator, other crane personnel, or other individuals with access to one or more displays described herein.

In some embodiments, crane collision avoidance system 100 may be configured to store and provide information regarding the one or more identified objects with location data, speed data, direction data, and/or other information determined or obtained by computer system 150. For example, crane collision avoidance system 100 may be configured to store predicted future location and/or route of detected danger objects for access later to assess potential accidents or collisions or accidents or collisions that did indeed occur. In some embodiments, crane collision avoidance system 100 may be configured to store information related to identified objects and/or other information determined or obtained by computer system 150 in electronic storage 170, as described further herein.

In various embodiments, crane collision avoidance system 100 may be configured to utilize various communications methodologies to establish connections and allow seamless information sharing across a network between components of crane collision avoidance system 100, electronic storage 170, one or more user devices 180, a remote sever 190, a remote display 200, and/or other components in communication with crane collision avoidance system 100. For example, crane collision avoidance system 100 may communicate with a cloud database via one or more cloud services.

In various embodiments, crane collision avoidance system 100 may be configured to automatically take action with respect to movement of the crane in response to detection of a potential accident or collision. For example, in response to detecting a potential accident or collision, crane collision avoidance system 100 may be configured to cause one or more components of the crane to move automatically or stop moving automatically in order to avoid a potential accident or collision. In some embodiments, crane collision avoidance system 100 may be configured to generate an alert signal based on the detection of a danger object (i.e., an object that may be at risk of a collision with the crane or one its components). In some embodiments, in response to detecting that a crane operator has not taken an action necessary to avoid a potential collision, crane collision avoidance system 100 may be configured to automatically take evasive action (i.e., cause the crane or one of its components to move or stop moving). In some embodiments, crane collision avoidance system 100 may be configured to automatically take evasive action based on a determination that the danger object still represents a potential collision after a predefined time, that the danger object is within a predefined threshold distance from the crane, that the danger object represents a potential collision within a predefined time threshold, and/or based on one or more other determinations related to detection of the danger object. In some embodiments, crane collision avoidance system 100 may be configured to take evasive action without requiring communication from the operator of the crane. In some embodiments, crane collision avoidance system 100 may be configured to take evasive action, as described above, by activating an interlock of the crane. For example, the interlock of the crane may be a brake or shutoff switch associated with the crane wheels, the crane boom, and/or one or more other components of the crane.

In various embodiments, crane collision avoidance system 100 may be configured to provide counterweight movement detection functionality. As used herein, counterweight movement detection functionality may comprise detecting movement of a crane counterweight and providing alerts of the potential danger. For example, crane collision avoidance system 100 may be configured to detect a counterweight swing based on information received from one or more devices or sensors of monitoring subsystem 110 and provide audio and/or visual alerts to the crane operator, other crane personnel, and/or other individuals within a vicinity of the movement of the crane counterweight to alert them to a potential danger.

In various embodiments, crane collision avoidance system 100 may be configured to provide load safe zone detection functionality. As used herein, load safe zone detection functionality may comprise identifying a load zone (i.e., an area under which any individual or object may be in danger due to a falling load or debris) or a load safe zone (i.e., an area outside the load zone in which individuals or objects are not at risk of danger due to a load of the crane) and providing alerts of the potential danger. For example, as depicted in FIG. 1, load zone 140 may comprise an area underneath an active load of boom 80 of crane 50. In some implementations, crane collision avoidance system 100 may be configured to identify a load zone based on attributes of the load determined by crane collision avoidance system 100 and/or telematics information for the crane. For example, crane collision avoidance system 100 may be configured to determine a size, shape, weight, and/or other attributes of an active load based on information received from one or more devices or sensors of monitoring subsystem 110. In some implementations, crane collision avoidance system 100 may be configured to provide a visual indication of a load zone (or a load safe zone) using lasers, lights, and/or otherwise highlighting or projecting an indication of the proximate location of the load zone so that the crane operator, other crane personnel, or individuals within a vicinity of the crane are aware of the load zone without having to look up.

In various embodiments, crane collision avoidance system 100 may be configured to monitor a load zone using the one or more devices or sensors of monitoring subsystem 110 and provide audio and/or visual alerts to the crane operator, other crane personnel, and/or other individuals within a vicinity of the crane when an object or individual passes within the load zone (or underneath a load). In some embodiments, crane collision avoidance 100 may be configured to monitor a load zone based on the location of one or more user devices 180. For example, in some embodiments, individual crane personnel or other individuals within a working area of a crane may be provided with or have a user device 180 configured to interface with or otherwise be identified and/or located by one or more devices or sensors of monitoring subsystem 110. In an example embodiment, the one or more user devices 180 of individual crane personnel or other individuals within a working area of a crane may comprise mobile phones, transponders, and/or other portable devices configured to be worn or carried by a user. In various embodiments, the one or more devices or sensors of monitoring subsystem 110 may be configured to triangulate a location of one or more user devices 180. In various embodiments, crane collision avoidance system 100 may be configured to detect when an individual enters a load zone based on the triangulated location of the one or more user devices 180. Responsive to determining that an individual has entered a load zone based on the triangulated location of the one or more user devices 180, crane collision avoidance system 100 may be configured to provide an alert to the crane operator, other crane personnel, and/or other individuals within a vicinity of the crane to alert them to the potential danger. For example, responsive to determining that a specific individual has entered a load zone based on the determination that a user device 180 associated with that individual has entered the load zone, crane collision avoidance system 100 may be configured to provide an alert to the user device 180 of that individual to alert the individual of the potential danger.

In various embodiments, crane collision avoidance system 100 may be configured to provide high voltage boom detection functionality. Cranes are typically used in close proximity to powerlines or other sources of electricity. As a result, crane operators, other crane personnel, or other individuals within a vicinity of the crane can be in danger of electrocution simply by being in close proximity to a crane operating in such circumstances. As used herein, high voltage boom detection functionality may comprise detecting when a boom or any other component of a crane has become energized due to contact with a power source (such as a powerline) and providing alerts of the potential danger. For example, crane collision avoidance system 100 may be configured to determine when the boom or another component of a crane has become energized due to contact with a power source based on information received from one or more devices or sensors of monitoring subsystem 110 and provide audio and/or visual alerts to the crane operator, other crane personnel, and/or other individuals within a vicinity of the movement of the crane counterweight to alert them to a potential danger.

As described herein, crane collision avoidance system 100 comprises a monitoring subsystem 110 including one or more devices or sensors configured to monitor an environment surrounding a crane, detect movement of crane components or objects within the environment surrounding the crane, or otherwise provide improved situational awareness to a crane operator. As also described herein, the one or more devices or sensors of monitoring subsystem 110 may be attached at various locations on a crane and to various components of a crane. In some embodiments, individual devices or sensors of monitoring subsystem 110 may be associated with one or more operating states of the crane. For example, different operating states may comprise when the crane is actively moving a load, when the crane is in operation (i.e., when the outriggers are deployed), when the crane is not in operation (i.e., when the outriggers are not deployed), when the crane is in transit, when the crane is in transit above a predefined speed, and/or one or more other operating states of the crane. In some embodiments, depending on the current operating state of the crane, only a subset of the one or more devices or sensors of monitoring subsystem 110 may be utilized and/or only a subset of the functionality of crane collision avoidance system 100 described herein may be active.

In various embodiments, a first operating state may be when the crane is in transit or when the outriggers are not deployed, and a second operating state may be when the crane is in operation (i.e., when the outriggers are deployed). Depending on the current operating state of the crane, crane collision avoidance system 100 may be configured to only utilize the one or more devices or sensors of monitoring subsystem 110 needed to provide the functionality associated with that operating state. For example, when in the first operating state, crane collision avoidance system 100 may be configured to utilize only the one or more devices or sensors of monitoring subsystem 110 that are ground-level or otherwise associated with operation from a first cab of the crane in which the crane operator sits to drive the crane when in transit. Meanwhile, when in the second operating state, crane collision avoidance system 100 may be configured to utilize only the one or more devices or sensors of monitoring subsystem 110 that are related to the operation of the crane (i.e., movement of the boom or lifting of loads) or otherwise associated with operation from a second movable cab of the crane in which the crane operator sits to utilize the boom of the crane.

When in the first operating state, crane collision avoidance system 100 may be configured to utilize monitoring subsystem 110 to provide (or activate) blind spot monitoring and/or collision avoidance functionality, but not counterweight swing detection, load safe zone detection, high voltage boom detection, and/or other functionality of crane collision avoidance system 100 described herein. In some embodiments, when in a first operating state, crane collision avoidance system 100 may also be configured to provide driver assistance functionality. In various embodiments, when in the first operating state, crane collision avoidance system 100 may be configured to provide audio and/or visual alerts (e.g., beeping sounds and/or flashing lights) when the crane is in motion. In some embodiments, crane collision avoidance system 100 may be configured to deactivate the audio and/or visual alerts when the crane is moving continuously (e.g., for a predefined distance or duration) over a predefined speed. For example, crane collision avoidance system 100 may be configured to deactivate a beeping sound (but not the flashing lights) when the crane is moving for more than 10 seconds over 10 mph. Crane collision avoidance system 100 may then be configured to turn the beeping sound back on when the crane has moved less than 10 mph for greater than 90 seconds. In some embodiments, crane collision avoidance system 100 may be configured to activate lights and/or a beeping sound automatically when the crane is powered on and the outriggers are not deployed to alert all individuals within a proximity of the crane that the crane may be moving. In some embodiments, the lights and/or beeping may be deactivated while the parking brake is activated.

In various embodiments, crane collision avoidance system 100 may be configured to determine when the outriggers of the crane have been deployed. Responsive to a determination that the outriggers of the crane have been deployed, crane collision avoidance system 100 may be configured to switch to a second operating system. For example, responsive to a determination that the outriggers of the crane have been deployed, crane collision avoidance system 100 may be configured to switch the active devices or sensors of monitoring subsystem 110 from the devices or sensors that are ground-level or associated with operation from a first cab of the crane to devices or sensors that are elevated or on the boom or associated with operation from a second movable cab of the crane. When in the second operating system, crane collision avoidance system 100 may be configured to utilize monitoring subsystem 110 to provide (or activate) blind spot monitoring, collision avoidance functionality, counterweight swing detection, load safe zone detection, and/or high voltage boom detection, but not any driver assistance functionality and/or other functionality of crane collision avoidance system 100 described herein.

In some circumstances, a crane may include a dolly configured to support the boom during transit. In such instances, one or more devices or sensors of monitoring subsystem 110 may be affixed to the dolly to monitor the area surrounding the dolly, detect movement of objects within the area surrounding the dolly, or otherwise provide improved situational awareness to a crane operator. For example, one or more devices or sensors affixed to a dolly of a crane may provide images of a blind spot in the rear of the dolly (and the crane), information regarding the crane when turning while in transit (as the dolly will swing from side to side in turns, thus changing the shape of the crane vehicle in transit, and information regarding objects in a proximity of the dolly, which may be particularly useful in turns when the dolly may swing and potentially contact objects within a vicinity of the crane. In various embodiments, the one or more devices or sensors of monitoring subsystem 110 that are affixed to a dolly may be affixed to one or more components of crane collision avoidance system 100 via a wired connection to a first cab of the crane (i.e., the cab of the crane in which the crane operator sits to drive the crane when in transit). In some embodiments, crane collision avoidance system 100 may be configured to intelligently filter out image or information received from one or more devices or sensors of monitoring subsystem 110 when turning. For example, one or more devices or sensors on a side of the crane cab (or chassis) may be disabled or filtered out to prevent those devices or sensors from detecting the swinging dolly as a potential danger object within a proximity of the crane. In some embodiments, one or more devices or sensors of monitoring subsystem 110 that are affixed to the crane may be disabled when a crane is in use. For example, a rear sensor on the crane cab (or chassis) may be automatically disabled when a dolly is in use to avoid false detection of the dolly as an object in close proximity of the crane cab.

As described herein, monitoring subsystem 110 of crane collision avoidance system 100 may include one or more devices or sensors. In some embodiments, the one or more devices or sensors may include one or more object detecting sensors 130, each which may comprise a radar device. In various embodiments, radar devices of monitoring subsystem 110 may be attached to a crane using a specialized sensor housing. For example, radar devices of monitoring subsystem 110 may be attached to a crane using a specialized sensor housing comprising a enclosure formed by an enclosure tube and enclosure back plate and that is attached to the crane using a specialized mounting bracket. In various embodiments, the mounting bracket may be configured to stabilize the radar device within the sensor housing. In some embodiments, this specialized sensor housing may be configured to house various radar devices.

In various embodiments, the specialized mounting bracket may be configured to prevent, direct, and/or guide scattered radar. For example, the mounting bracket may include one or more flanges and/or specific hole patterns. When mounted to a crane via the specialized mounting bracket, the orientation of the radar device with respect to the flanges and/or hole pattern(s) may allow back scatter to be controlled. For example, by moving the radar device within sensor housing by mounting the sensor device to the specialized mounting bracket in various positions, an operator may modify radar back scatter when the radar device is active.

Electronic storage 170 may include electronic storage media that electronically stores information. In some embodiments, electronic storage media of electronic storage 170 may be provided integrally (i.e., substantially non-removable) with one or more components of crane collision avoidance system 100 and/or comprise removable storage that is connectable to one or more components of crane collision avoidance system 100 via, for example, a port (e.g., a USB port, a Firewire port, etc.) or a drive (e.g., a disk drive, etc.). Electronic storage 170 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Electronic storage 170 may be a separate component within crane collision avoidance system 100, or electronic storage 170 may be provided integrally with one or more other components of crane collision avoidance system 100 (e.g., computer system 150). Although electronic storage 170 is shown in FIG. 3 as a single entity, this is for illustrative purposes only. In some implementations, electronic storage 170 may comprise a plurality of storage units. These storage units may be physically located within the same device, or electronic storage 170 may represent storage functionality of a plurality of devices operating in coordination

Electronic storage 170 may store software algorithms, information received from one or more devices or sensors of monitoring subsystem 110, information determined by processor(s) 152, information received remotely, and/or other information that enables crane collision avoidance system 100 to function properly. For example, electronic storage 170 may store location data, speed data, direction data, and/or other information related to one or more objects; information related to a crane or load, including size, shape, type, weight, features or functionality, maintenance history, usage history, and/or other information related to the crane or a load; crane operator information; an identification of, and/or information related to, the one or more sensors of monitoring subsystem 110; an identification of, and/or information related to the one or more displays of display subsystem 160; and/or other information related to crane collision avoidance system 100.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a tangible computer readable storage medium may include read only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

Although the components of crane collision avoidance system 100, electronic storage 170, one or more users devices 180, remote server 190, and remote display 200 are shown to be connected to interface 102 in FIG. 3, any communication medium may be used to facilitate interaction between any components of crane collision avoidance system 100. One or more components of crane collision avoidance system 100 may communicate with each other through hard-wired communication, wireless communication, or both. For example, one or more components of crane collision avoidance system 100 may communicate with each other through a network. For example, processor(s) 152 may wirelessly communicate with electronic storage 1170. By way of non-limiting example, wireless communication may include one or more of radio communication, Bluetooth communication, Wi-Fi communication, cellular communication, infrared communication, or other wireless communication. Other types of communications are contemplated by the present disclosure.

Although processor(s) 152 are illustrated in FIG. 3 as a single component, this is for illustrative purposes only. In some implementations, processor(s) 152 may comprise a plurality of processing units. These processing units may be physically located within the same device, or processor(s) 152 may represent processing functionality of a plurality of devices operating in coordination. Processor(s) 152 may be configured to execute one or more components by software; hardware; firmware; some combination of software, hardware, and/or firmware; and/or other mechanisms for configuring processing capabilities on processor(s) 152.

It is to be understood that the invention is not limited in its application to the details of construction and the arrangement of the components set forth herein. The invention is capable of other embodiments and of being practiced or being carried out in various ways. Variations and modifications of the foregoing are within the scope of the present invention. It should be understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

While the preferred embodiments of the invention have been shown and described, it will be apparent to those skilled in the art that changes and modifications may be made therein without departing from the spirit of the invention, the scope of which is defined by this description.

Reference in this specification to “one implementation”, “an implementation”, “some implementations”, “various implementations”, “certain implementations”, “other implementations”, “one series of implementations”, or the like means that a particular feature, design, structure, or characteristic described in connection with the implementation is included in at least one implementation of the disclosure. The appearances of, for example, the phrase “in one implementation” or “in an implementation” in various places in the specification are not necessarily all referring to the same implementation, nor are separate or alternative implementations mutually exclusive of other implementations. Moreover, whether or not there is express reference to an “implementation” or the like, various features are described, which may be variously combined and included in some implementations, but also variously omitted in other implementations. Similarly, various features are described that may be preferences or requirements for some implementations, but not other implementations.

The language used herein has been principally selected for readability and instructional purposes, and it may not have been selected to delineate or circumscribe the inventive subject matter. Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A crane collision avoidance system comprising:
one or more image capturing devices attached to a crane and configured to capture images of an area surrounding the crane;
one or more object detecting sensors attached to the crane and configured to detect objects within a proximity of the crane; and
a computer system comprising one or more physical computer processors and computer readable instructions that, when executed by the one or more physical computer processor, program the computer system to:
receive one or more images from the one or more image capturing devices;
obtain location, speed, and direction data for one or more objects external to the crane from the one or more object detecting sensors;
obtain crane telematics information indicating a position, orientation, speed of movement, and/or direction of movement of one or more components of the crane;
identify in real-time a danger object from the one or more objects based on the location, speed, and direction data for the one or more objects and the crane telematics information;
generate a display comprising a view of the area surrounding the crane based on the one or more images received from the one or more image capturing devices, wherein the display includes an indication of the identified danger object; and
provide an audible warning to an operator of the crane responsive to identification of the danger object.

2. The crane collision avoidance system of claim 1, wherein the crane comprises a dolly configured to support a boom of the crane during transit, wherein at least one image capturing device or object detecting sensor is attached to the dolly and is configured to provide information regarding objects in a proximity of the dolly to the computer system.

3. The crane collision avoidance system of claim 2, wherein the at least one image capturing device or object detecting sensor attached to the dolly is connected to a cab of the crane via a wired connection.

4. The crane collision avoidance system of claim 1, wherein the computer system is further programmed to:
detect a counterweight swing on the crane based on the one or more images received from the one or more image capturing devices and/or information obtained from the one or more object detecting sensors; and
provide an alert to the operator of the crane, other crane personnel, and/or other individuals within a vicinity of the crane responsive to detection of the counterweight swing.

5. The crane collision avoidance system of claim 1, wherein the computer system is further programmed to:
monitor a load zone based on the one or more images received from the one or more image capturing devices and/or information obtained from the one or more object detecting sensors, wherein the load zone comprises an area under an active load of the crane; and
provide an alert to the operator of the crane, other crane personnel, and/or other individuals within a vicinity of the crane responsive to detection of an object inside the load zone.

6. The crane collision avoidance system of claim 5, wherein the computer system is further programmed to:
determine one or more attributes of the active load based on the one or more images received from the one or more image capturing devices and/or information obtained from the one or more object detecting sensors; and
identify the load zone based on the one or more attributes of the active load and the crane telematics information.

7. The crane collision avoidance system of claim 5, wherein the computer system is further programmed to:
cause a visual indication of a proximate location of the load zone to be provided to the operator of the crane, other crane personnel, and/or other individuals within a vicinity of the crane.

8. The crane collision avoidance system of claim 1, wherein the computer system is further programmed to:
detect that one or more components of the crane have been energized due to contact with a power source based on information obtained from the one or more object detecting sensors; and
provide an alert to the operator of the crane, other crane personnel, and/or other individuals within a vicinity of the crane responsive to detection that at least one component of the crane has been energized due to contact with a power source.

9. The crane collision avoidance system of claim 1, wherein the computer system is further programmed to:
automatically activate an interlock of the crane responsive to identification of the danger object.

10. The crane collision avoidance system of claim 9, wherein the computer system is programmed to automatically activate an interlock of the crane responsive to identification of the danger object without requiring communication from the operator of the crane.

11. The crane collision avoidance system of claim 1, wherein the display comprising the view of the area surrounding the crane comprises a display of one or more blind spots of the operator of the crane.

12. The crane collision avoidance system of claim 1, wherein the display comprising the view of the area surrounding the crane comprises a 360-degree view of the area surrounding the crane.

13. The crane collision avoidance system of claim 1, wherein a first subset of the one or more image capturing devices and the one or more object detecting sensors is associated with a first operating state of the crane, and wherein a second subset of the one or more image capturing devices and the one or more object detecting sensors is associated with a second operating state of the crane.

14. The crane collision avoidance system of claim 13, wherein the first operating state of the crane includes when the crane is in transit or when outriggers of the crane are not deployed, and wherein the second operating state of the crane includes when the crane is in operation or when one or more outriggers of the crane are deployed, wherein only a first set of features of the crane collision avoidance system are active when the crane is in the first operating state, and wherein only a second set of features of the crane collision avoidance system are active when the crane is in a second operating state.

15. The crane collision avoidance system of claim 14, wherein the computer system is further programmed to:
determine that one or more outriggers of the crane have been deployed; and
responsive to the determination that the one or more outriggers of the crane have been deployed, switch from the first operating state of the crane to the second operating state of the crane.

16. The crane collision avoidance system of claim 1, wherein the one or more object detecting sensors attached to the crane are configured to determine the location, speed, and direction data for the one or more objects external to the crane and provide determined location, speed, and direction data to the computer system.

17. The crane collision avoidance system of claim 1, wherein the computer system is programmed to receive sensor data related to one or more objects external to the crane from the one or more object detecting sensors and determine the location, speed, and direction data for the one or more objects external to the crane based on the sensor data received from the one or more object detecting sensors.

18. The crane collision avoidance system of claim 1, wherein to identify a danger object from the one or more objects, the computer system is programmed to predict a future location and a route of the one or more objects external to the crane using a predictive algorithm and a trajectory analysis of the one or more objects external to the crane.
